(19) United States
(12) Patent Application Publication
(10) Pub. No.: US 2010/0057333 A1
(43) Pub. Date: Mar. 4, 2010

(54) NAVIGATION SYSTEM

(75) Inventor: Il Dong YUN, Gyeonggi-do (KR)

Correspondence Address: KNOBBE MARTENS OLSON & BEAR LLP, 2040 MAIN STREET, FOURTEENTH FLOOR, IRVINE, CA, 92614, US

(73) Assignee: HANKUK UNIVERSITY OF FOREIGN STUDIES RESEARCH AND INDUSTRY-UNIVERSITY COOPERATION FOUNDATION, Gyeonggi-do (KR)

(21) Appl. No.: 12/199,522

(22) Filed: Aug. 27, 2008

(51) Int. Cl. G08G 1/00

(52) U.S. Cl. 701/117; 701/200

(57) ABSTRACT

Navigation techniques are provided. In one embodiment, an apparatus may include a receiver for receiving broadcast data including an update of traffic data, a decoder for extracting the update of the traffic data, a memory for storing standard traffic data, and a controller to generate traffic information based on the update of the traffic information and the standard traffic data.

### TECHNICAL FIELD

The present disclosure relates generally to navigation technologies.

### BACKGROUND

Many cities and urban areas throughout the world may face congestion and traffic problems as the number of vehicles on the roads continues to increase. As a result, there may be an increasing demand for up-to-date traffic and travel information that may help drivers plan and choose their routes and ease growing congestion. In response to the demand, there are efforts to develop navigation and information technologies, e.g., vehicle navigation technologies that may guide drivers to their destinations more easily and efficiently. Using such navigation technologies, vehicles may be continuously or intermittently provided with traffic information (e.g., congestion, estimated travel-time information, road obstruction information, etc.) to search and determine the optimum route to the destination.

In order to provide traffic information in an efficient and reliable manner, TPEG (Transport Protocol Experts Group) technology has been developed to facilitate the transmission of information within the multimedia broadcasting environment from service providers to end-users. TPEG technology may provide a multimodal traffic and travel information data protocol for transmitting content to the end-user, regardless of location or client type in use. Using TPEG technology, traffic-related information may be provided to drivers through conventional communication channels, for example, through FM broadcasting or DMB (Digital Multimedia Broadcasting). For more efficient broadcasting of traffic information, drivers may be provided with continuously updated information of the latest traffic conditions.

### BRIEF DESCRIPTION OF THE DRAWINGS

FIG. 1 shows a schematic block diagram of one illustrative embodiment of a system configured to provide traffic information.

FIG. 2 shows an illustrative embodiment of a traffic information transmitting device.

FIG. 3 shows an illustrative embodiment of TPEG data having traffic status events.

FIG. 4 shows an illustrative embodiment of a traffic information receiving device.

FIG. 5 is a flow chart that illustrates updating a traffic path in one embodiment.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

Various embodiments of navigation techniques are disclosed. In one embodiment, a system may include a content provider configured to provide multimedia content, a traffic information source configured to provide an update of traffic information, and a broadcasting center configured to multiplex the multimedia content and the update of the traffic information to generate broadcasting data.

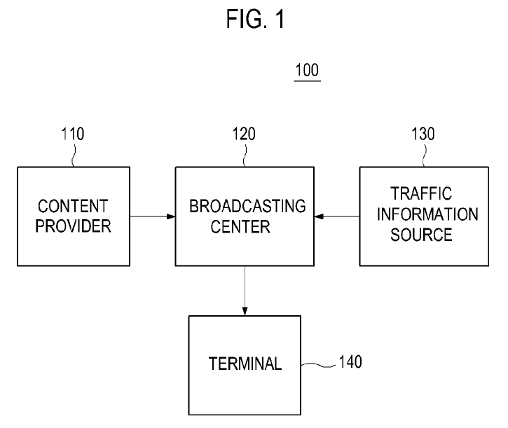

Referring to FIG. 1, one embodiment of a system 100 that may be configured to provide traffic information to a terminal is illustrated. As depicted, system 100 may include a content provider 110, a broadcasting center 120, a traffic information source 130, and a terminal 140. Content provider 110 may produce various types of multimedia content including but not limited to: video, audio, text, images, animations, etc. In one embodiment, content provider 110 may include a server configured to provide digital content, such as digital movie (or music), to be broadcast to the public or transmitted to specific users (e.g., subscribers to the digital contents). Content provider 110 may transmit the multimedia content to broadcasting center 120. Traffic information source 130 may collect traffic conditions to generate traffic information. For example, traffic information source 130 may obtain the latest traffic information from traffic cameras that may be mounted over heavily traveled roads to monitor traffic conditions. The traffic information may include congestion level, traffic volume, travel time, road accident/travel restriction information, visibility, weather, or the like. Traffic information source 130 may transmit the traffic information to broadcasting center 120. Broadcasting center 120 may multiplex the multimedia content from content provider 110, and the traffic information from traffic information source 130 to generate broadcasting data to be transmitted to terminal 140.

Broadcasting center 120 may include a traffic information transmitting device configured to transmit the broadcasting data to terminal 140, which may include a traffic information receiving device configured to receive the broadcasting data. In some embodiments, the broadcasting data may be transmitted to terminal 140 through mobile communications systems such as FM broadcasting, Global System for Mobile Communications (GSM), Global Positioning System (GPS), Digital Mobile Multimedia (DMB), Code Division Multiple Access (CDMA), High-Speed Down Link Packet Access (HSDPA), Wi-Bro Wireless Broadband, or the like. For example, when system 100 is implemented by using DMB, the digital multimedia broadcasting technique may include, without limitation: a terrestrial DMB, a satellite DMB or the like. The terrestrial DMB may broadcast various type of broadcasting data via transmitting towers that may transmit the broadcasting data from broadcasting center 120 to terminal 140, whereas the satellite DMB broadcasts the broadcasting data via satellite(s) to cover a wide range of areas in which terminal 140 may receive the broadcasting data. Although system 100 is illustrated using mobile terminals such as mobile phones, it should be appreciated that it is equally suitable for numerous types of mobile terminal devices having mobile communication capability such as a DMB phone, a PDA, a car DMB, a cellular phone, a laptop computer, a portable email device, or the like. In addition, although only one (mobile) terminal 140 is shown in FIG. 1 for illustrative purposes, it is understood that any number of mobile terminals (which access broadcasting center 120) may be employed in system 100.

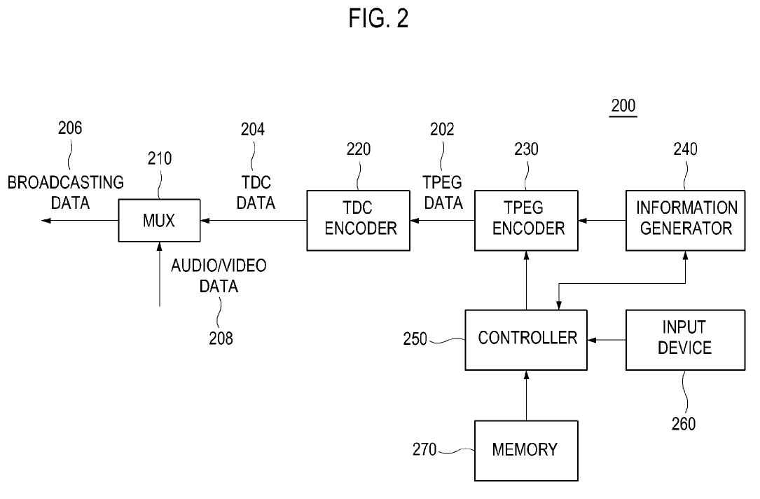

Referring to FIG. 2, one embodiment of a traffic information transmitting device 200 is illustrated. Traffic information transmitting device 200 may include a multiplexer (MUX 210), a transparent data channel (TDC) encoder 220, a TPEG encoder 230, an information generator 240, a controller 250, an input device 260, and a memory 270. Traffic information transmitting device 200 may be included as a part of broadcasting center 120 of FIG. 1. Broadcasting center 120 may receive traffic information from traffic information source 130 and may store the traffic information in memory 270 of traffic information transmitting device 200. Memory 270 may include, without limitation: any computer readable media, such as a floppy disk, CD-ROM, DVD, a detachable memory, a USB memory, a memory stick, a memory card, or the like. Controller 250 may retrieve the traffic information from memory 270 to transmit the traffic information to TPEG encoder 230.

In some embodiments, controller 250 may receive a command input by a user/operator through input device 260. That is, the user may enter a command to control the operation of traffic information transmitting device 200 by using input device 260. For example, the command may indicate the types of events that are included in the traffic information to be transmitted to terminal 140 at a given time. Input device 260 may include any type of devices that allow the user to enter the command to adjust the operation of traffic information transmitting device 200.

In some embodiments, information generator 240 may generate additional information that may describe the status of road traffic conditions corresponding to the traffic information (e.g., traffic status events) that may be retrieved from memory 270 under the control of controller 250. For example, information generator 240 may generate additional information on restaurants, hotels, attractions, gas stations or the like that are associated with the traffic status events so that the additional information may be transmitted to terminal 140 for user's reference. Information generator 240 may transmit additional information to TPEG encoder 230. TPEG encoder 230 may integrate the additional information with the traffic information (e.g., traffic events) that may be received from controller 250. For example, TPEG encoder 230 may pack the contents of the traffic events and the additional information to generate TPEG data 202. TPEG encoder 230 may generate TPEG data 202 according to the specification of the standard such as TPEG (Transport Protocol Experts Group) standards. In this way, traffic information transmitting device 200 may transmit more detailed information associated with the traffic status as well as the traffic information on the roads to terminal 140. In some embodiments, terminal 140 may determine whether terminal 140 may receive the additional information in addition to the traffic information, and may previously register the determined status to broadcasting center 120, so that traffic information transmitting device 200 may operate differently for each terminal depending of the previously registered status for that terminal.

In some embodiments, TPEG encoder 230 may generate TPEG data 202 when an update or a change occurs to the traffic information that broadcasting center 120 receives from traffic information source 130. Alternatively, TPEG encoder 230 may generate TPEG data 202 on a periodic basis so that terminal 140 may receive an update of the TPEG data 202 periodically. In either case, controller 250 may compare the traffic information with initial traffic information (e.g., standard traffic information) and may generate an update of the traffic information based at least in part on the comparison result. The standard information data may have been determined in advance and stored in memory 270 that may be accessed by controller 250 to retrieve the standard traffic information. For example, the standard traffic information may be categorized into one or more types according to predetermined criteria such as a time period when the standard traffic information may be transmitted to terminal 140. After controller 250 performs the initial comparison to generate the initial update of the traffic information, controller 250 may compare current traffic information (i.e., newly received from traffic information source 130) with previous traffic information to generate a next update of the traffic information. For example, the traffic information may include time-varying map data, and controller 250 may allow TPEG encoder 230 to encode an updated part (i.e., delta) of the map data between a previous and a current time period when the traffic information may be transmitted to terminal 140. TPEG encoder 230 may encode the updated part of the traffic information (i.e., the difference of the traffic information between the previous and the current time period) and may generate TPEG data 202. In this way, traffic information transmitting device 200 may reduce the amount of traffic data that may be carried by TPEG data 230 to be transmitted to terminal 140.

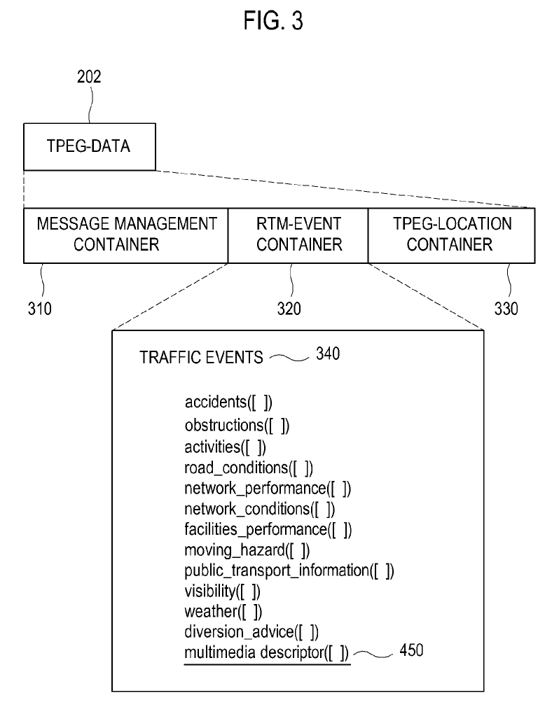

Referring to FIG. 3, one embodiment of TPEG data 202 including traffic status events is illustrated. As shown in FIG. 3, TPEG data 202 may include a message management container 310, a RTM event container 320 and a TPEG location container 330. Message management container 310 may carry information about date, time, and occurrence time of a message, and RTM event container 320 may carry traffic information about road links and lanes. TPEG location container 330 may carry location and description information of a road link to which traffic information may be related.

As shown in FIG. 3, RTM event container 320 may include one or more RTM traffic events 340 that may be generated when the traffic information may be loaded into TPEG encoder 230. Each of traffic events 340 may have an identifying name including, for example, “Accidents,” “Obstructions,” “Activities,” “Road conditions,” “Network performance,” “Network conditions,” “Facilities performance,” “Moving hazard,” “Public transport information,” “Visibility,” “Weather,” “Diversion advice,” or “Multimedia descriptor.” In some embodiments, each element contained in traffic events 340 may indicate the traffic status for one or more lanes of a road—each element may include traffic information about the corresponding lane number that indexes the corresponding lane. For example, each element may be defined as an array, the size of which may correspond to the number of lanes, where array index ‘1’ may indicate a first lane, array index ‘2’ may indicate a second lane, and so forth.

In some embodiments, the element “Accidents” of traffic events 340 may indicate situations where road users (e.g., vehicles, animals and people) do not behave in a predictable or safe manner, resulting in either collisions with other road users or roadside objects. The element “Obstructions” may indicate situations where some road users or other causes may make it difficult or impossible for other road users to progress along that part of the roadway. The element “Activities” may indicate events that may have an impact on the road traffic, and the element “Road conditions” may indicate changes to the surface conditions of a road (e.g., disruptions to the surface, changes to the road markings, potholes, etc.) that may affect the progress of the road users. The element “Network performance” may show the effect on road users (e.g., delay, flow or speed) that arises our of external events, and the element “Network conditions” may indicate changes to network conditions planned, imposed or advised by the road network operator that affect the drivers, vehicles and routing. The element “Facilities performance” may indicate the changes to the availability of control, assistance and roadside services, and the element “Moving hazard” may indicate situations in which non-stationary road users make it hazardous for others to use the road. The element “Public transport information” may indicate an abnormal operation of all forms of public transport which may affect the road user's journey. The element “Visibility” may indicate the changes to the existing roadway conditions that may affect the road user's ability to see the road or other road users ahead, and the element “Weather” may show the weather conditions that may affect the progress of the road users. The element “Diversion advice” may indicate alternative routes that may be advised via service providers. Although examples of traffic events are described above, it should be appreciated that RTM event container 320 may include various different elements of traffic events depending on the implementation requirements.

In some embodiments, the element “Multimedia descriptor” may include various types of additional information (e.g., multimedia data) on, for example, traveling, dining, shopping and the like. The additional information may have various data formats such as video, audio, text or the like. For example, the additional information may include a data file such as a video advertisement clip that may introduce restaurants in the area through which a vehicle equipped with terminal 140 may be passing. The element “Multimedia descriptors” may include more than one data file, and in this case, the element “Multimedia descriptors” may associate segmentation information such as an identifier, a data length, a data type, a data attribute or the like for each data file.

Referring back to FIG. 2, TPEG encoder 230 may generate TPEG data 202 based at least in part on the traffic information from controller 250 and the additional information from information generator 240. TPEG encoder 230 may transmit TPEG data 202 to TDC encoder 220. For example, TPEG data 202 may be generated in compliance with the specification published by the standard organization such as TPEG (Transport Protocol Experts Group). In some embodiments, TDC encoder 220 may encode TPEG data 230 to generate a TDC data 204 to be transmitted to terminal 140 via a communication channel such as Transparent Data Channel (TDC) of the DMB communication system. Although the TDC is adopted as an example communication channel in this embodiment, any channel capable of carrying TPEG data 202 may be used to transmit TPEG data 202 to terminal 140. MUX 210 may receive TDC data 204 from TDC encoder 220, and may receive multimedia data (e.g., DMB audio/video data) 208 transmitted from content provider 110. MUX 210 may multiplex TDC data 204 and multimedia data 208 to generate broadcasting data 206. For example, MUX 210 may add an identifier to TDC data 204 and multimedia data 208 and may allow terminal 140 to distinguish TDC data 204 and multimedia data 208.

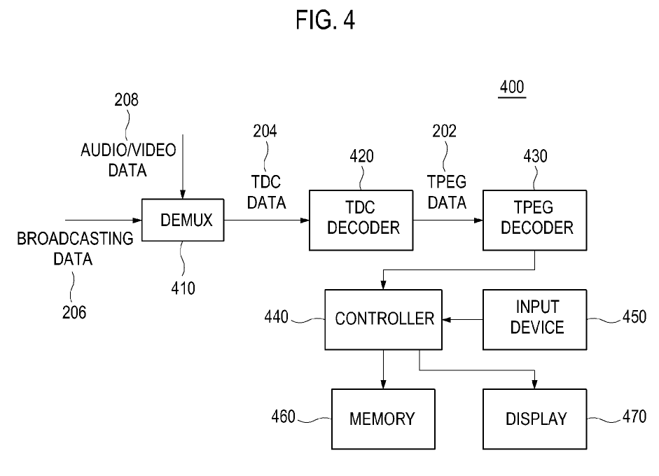

Referring to FIG. 4, one embodiment of a traffic information receiving device 400 is illustrated. Traffic information receiving device 400 may include a de-multiplexer (DEMUX 410), a TDC decoder 420, a TPEG decoder 430, a controller 440, an input device 450, a memory 460, and a display 470. Traffic information receiving device 400 may be included in terminal 140 of FIG. 1, and DEMUX 410 of terminal 140 may receive broadcasting data 206 from broadcasting center 120 of FIG. 1. DEMUX 410 may de-multiplex broadcasting data 206 into multimedia data (e.g., DMB audio/video data) 208 and TDC data 204. For example, DEMUX 410 may refer to the identifier contained in broadcasting data 206 to distinguish between TDC data 204 and multimedia data 208. DEMUX 410 may transmit multimedia data 208 to a multi-media processing unit (not shown) and may transmit TDC data 204 to TDC decoder 420. TDC decoder 420 may perform an error check correction process that may detect errors that may occur during the transmission from traffic information transmitting device 200 to traffic information receiving device 400. For example, TDC decoder 420 may perform a CRC check (cyclic redundancy check) that may detect and correct errors in TDC data 204. In this way, TDC decoder 420 may decode TDC data 204 to extract TPEG data 202 from TDC data 204. TDC decoder 420 may transmit TPEG data 202 to TPEG decoder 430. TPEG decoder 430 may unpack the content of TPEG data 202 to extract the traffic data such as, but not limited to, traffic events, and the additional information under the control of controller 440. For example, TPEG data 202 may be decoded in compliance to requirements by the specification of the standards, such as TPEG (Transport Protocol Experts Group).

In some embodiments, a user of terminal 140 may enter a command to control the operations of traffic information receiving device 400 by using input device 450. For example, the command may indicate the types of traffic events that may be extracted from TPEG data 202 to be displayed for the user's reference at a given time. Traffic information receiving device 400 may include various types of input devices 260 including, but not limited to, a keypad, a keyboard, a mouse, a touch pad, a touch screen, a pointing device, a trackball, a light pen, a joystick, a speech recognition device, a stylus device, an eye and head movement tracker, a digitizing tablet, a barcode reader, or the like, each of which may provide the user with an interface to enter a user command to traffic information receiving device 400.

TPEG decoder 430 may transmit traffic data to controller 440. The traffic data received from traffic information transmitting device 200 may indicate a difference between initial traffic information (e.g., standard traffic information) and current traffic information that may show the traffic status at the time of transmitting the traffic data from traffic information transmitting device 200. The traffic data may include the updated part of the traffic information (i.e., the difference of the traffic information between the previous and the current time period of transmitting the traffic data). When traffic information receiving device 400 receives the first traffic data from broadcasting center 120, traffic information receiving device 400 may combine the traffic data with the standard traffic information and may generate the traffic information. In this case, controller 440 may search memory 460 and may retrieve the standard traffic information based on certain criteria. For example, the standard traffic information may be categorized into one or more types according to a time period when the standard traffic data may be used by traffic information receiving device 400. The standard traffic information may have been determined in advance and recorded in memory 460 that may be accessed by controller 440 which may retrieve the standard traffic information. Memory 460 may include, without limitation, any computer readable media, such as, but not limited to, a floppy disk, CD-ROM, DVD, a detachable memory, a USB memory, a memory stick, a memory card, or the like.

Controller 440 may combine the traffic data from TPEG decoder 430 and the standard traffic information retrieved from memory 460 and may generate initial traffic information. For example, the initial traffic information may include various traffic events and the multimedia descriptors, for example, those depicted in FIGS. 3 and 4. After the controller 440 may perform the initial combination and may generate the initial traffic information, controller 440 may combine a next traffic data (i.e., newly received from traffic information transmitting device 200) with the initial traffic information and may generate next traffic information. Controller 440 may repeat the above-described combination process. That is, when controller 440 receives new traffic data, controller 440 may combine the new traffic data with the previous traffic information and may generate current traffic information.

In some embodiments, controller 440 may update a path to a destination based at least in part on the current traffic information. Controller 440 may receive an input from a user through input device 450 and may adjust the process of updating the new path. For example, controller 440 may update the path on a basis of minimum time, minimum distance, most use of highway or the like according to the user's input. Controller 440 may transmit the traffic information to display 470 which may display the traffic information for the user's reference. Before the traffic information receiving device 400 may receive any traffic data from broadcasting center 120, controller 440 may use the standard traffic data previously stored in memory 460 and may determine a path to the destination. In this way, controller 440 may be allowed to use the standard traffic information to provide the traffic status with the user even before the traffic information receiving device 400 may receive the traffic data from the broadcasting center 120. For example, controller 440 may cause display 470 to display the traffic status by using the standard traffic information especially when a major intersection may show up within a few minutes' driving from a starting point.

Controller 440 may generate supplementary information in addition to the traffic information by using the traffic events and the additional information which may be contained in the traffic data from broadcasting center 120. Controller 440 may allow display 470 to display the supplementary information, thereby facilitating the user's selecting a new path. For example, controller 440 may generate the supplementary information including, but not limited to, a difference in TOA (Time of Arrival), a gap between the re-routed path and an original path, and a cause of change. The user may select the optimum path between the original path and the re-routed path(s) and input his/her selection through input device 450. In this way, terminal 140 may provide the supplementary information on the original path and the re-routed path(s) so that a road showing a big difference in the supplementary information may be selected by the user. That is, terminal 140 may make it possible to illustrate, for example, (i) which way may be congested on the path and thus (ii) through which way the path should be re-routed, and (iii) what degree of advantage may be achieved. When more than one option (a re-routed path) that falls within the threshold of time or distance may be provided, all the options may be provided for user's selection.

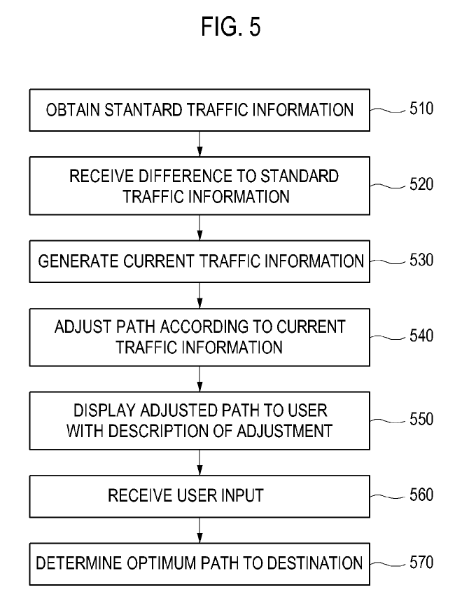

Referring to FIG. 5, a method for updating a traffic path is illustrated in accordance with one embodiment. At block 510, controller 440 of traffic information receiving device 400 may search memory 460 and may obtain standard traffic information that may be stored in memory 460. In some embodiments, controller 440 may retrieve the standard traffic information from memory 460 based on certain criteria. The standard traffic information may be categorized into one or more patterns according to a time period when the standard traffic information may be used by traffic information receiving device 400. For example, the standard traffic information may have a different pattern depending on whether, for example, it may be a commuting time during a weekday, a day time, night time during a weekday, weekends or a holiday. The standard traffic information may have been determined in advance and stored in memory 460. Memory 460 may include, without limitation, any computer readable media, such as a floppy disk, CD-ROM, DVD, a detachable memory, a USB memory, a memory stick, a memory card, or the like.

At block 520, traffic information receiving device 400 may receive traffic data from broadcasting center 120. The traffic data may indicate a difference between standard traffic information (i.e., initial traffic information) and current traffic information. The traffic data may include the updated part of the current traffic information in comparison with the standard traffic information. At block 530, controller 440 may combine the traffic data from TPEG decoder 430, and the standard traffic information retrieved from memory 460 and may generate current traffic information. For example, the traffic information may include various traffic events and the multimedia descriptors, such as, but limited to, those illustrated in FIGS. 3 and 4. After controller 440 may perform the initial combination and may generate the current traffic information, controller 440 may combine current traffic data (i.e., newly received from traffic information transmitting device 200) with the previous traffic information and may generate next traffic information. In this case, the traffic data may include the difference of the traffic information between the previous and the current time period of transmitting the traffic data.

At block 540, controller 440 may adjust a path according to the current traffic information. That is, controller 440 may re-route a path to the destination by using the traffic information at a given time. Controller 440 may receive an input from a user through input device 450 and may adjust the process of updating the path. For example, controller 440 may update the path on the basis of, for example, minimum time, minimum distance, most use of highway or the like according to the user's input. Controller 440 may generate supplementary information by using the traffic events and the additional information that may be contained in the traffic data from broadcasting center 120.

At block 550, controller 440 may transmit the traffic information to display 470 which may display the traffic information for the user's reference. In some embodiments, controller 440 may allow display 470 to display the supplementary information, which may facilitate the user's selection of a new path. For example, controller 440 may generate the supplementary information including, but not limited to, a difference in TOA (Time of Arrival), a gap between the re-routed path and an original path, and a cause of change. At block 560, controller 440 may control input device 450 to receive an input from a user so that the user may select an optimum path between the original path and the re-routed path(s) and may input their selection through input device 450. In this way, terminal 140 may provide the supplementary information on the original path and the re-routed path(s) so that a road showing a difference to the supplementary information may be selected by the user. That is, terminal 140 may make it possible to illustrate (i) which way may be congested on the path and thus (ii) through which way the path may be re-routed, and (iii) what degree of advantage may be achieved. When more than one option (re-routed path) that falls within the threshold of time or distance may be provided, all the options may be provided for user's selection. At block 570, controller 440 may determine the optimum path to the destination upon receiving the user input.

In light of the present disclosure, those skilled in the art will appreciate that the apparatus and methods described herein may be implemented in hardware, software, firmware, middleware, or combinations thereof and utilized in systems, subsystems, components, or sub-components thereof For example, a method implemented in software may include computer code to perform the operations of the method. This computer code may be stored in a machine-readable medium, such as a processor-readable medium or a computer program product, or transmitted as a computer data signal embodied in a carrier wave, or a signal modulated by a carrier, over a transmission medium or communication link. The machine-readable medium or processor-readable medium may include any medium capable of storing or transferring information in a form readable and executable by a machine (e.g., by a processor, a computer, etc.).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A system comprising:
a content provider configured to provide multimedia content;
a traffic information source configured to provide traffic information; and
a broadcasting center configured to receive the traffic information to generate an update of the traffic information, and further configured to multiplex the multimedia content and the update of the traffic information to generate broadcasting data.

2. The system of claim 1, wherein the traffic information source is configured to provide the traffic information periodically.

3. The system of claim 1, wherein the broadcasting center is configured to generate the update of the traffic information based at least in part on a difference between previous traffic information and current traffic information.

4. The system of claim 1, further comprising a terminal configured to receive the broadcasting data.

5. The system of claim 4, wherein the terminal includes a receiving unit configured to decode the broadcasting data to restore the traffic information.

6. The system of claim 1, wherein the broadcasting data comprises a plurality of traffic events.

7. The system of claim 6, wherein the plurality of traffic events are encoded according to a TPEG (Transport Protocol Experts Group) standard.

8. The system of claim 7, wherein the plurality of traffic events comprise at least one of an accident, an obstruction, an activity, a moving hazard, a visibility or a weather condition.

9. The system of claim 4, wherein the terminal includes a display configured to display the traffic information.

10. The system of claim 4, wherein the terminal includes an input unit configured to receive a user input.

11. An apparatus comprising:
a receiver configured to receive a broadcast data including an updated part of traffic data;
a decoder configured to extract the updated part of the traffic data;
a memory configured to store standard traffic information; and
a controller configured to generate traffic information based at least in part on the updated part of the traffic data and the standard traffic information.

12. The apparatus of claim 11, further comprising:
a display configured to display the traffic information.

13. The apparatus of claim 11, wherein the receiver is configured to receive the updated part of the traffic data periodically.

14. The apparatus of claim 11, wherein the standard traffic information is categorized into a plurality of patterns according to a time period when the standard traffic information is used.

15. The apparatus of claim 14, wherein the updated part of the traffic data comprises a difference between previous traffic information and current traffic information.

16. The apparatus of claim 11, wherein the controller is configured to generate a rerouted path based on the traffic information.

17. The apparatus of claim 16, wherein the controller is configured to generate supplementary information based on the traffic data.

18. The apparatus of claim 17, wherein the supplementary information comprises at least one of a difference in TOA (Time of Arrival), a gap between the rerouted path and an original path, or a cause of change.

19. The apparatus of claim 18, wherein the display is configured to display the supplementary information.

20. The apparatus of claim 17, further comprising:
an input unit configured to receive a user input.

21. The apparatus of claim 20, wherein the controller is configured to re-route a path based on the user input.

22. The apparatus of claim 11, wherein the apparatus comprises a portable device.

23. The apparatus of claim 22, wherein the apparatus comprises a cellular phone.

24. A method comprising:
receiving standard traffic information;
receiving an updated part of traffic information;
generating traffic data based on the updated part of the traffic information and the standard traffic information;
generating a rerouted path according to the traffic data; and
displaying the rerouted path.

25. The method of claim 23, further comprising:
receiving an input from a user to adjust the path.

26. The method of claim 25, wherein said receiving the updated part of the traffic information comprises receiving the updated part of the traffic information periodically.

27. The method of claim 25, wherein the standard traffic information is categorized into a plurality of patterns according to a time period when the standard traffic information is used.

28. The method of claim 27, wherein the updated part of the traffic information comprises a difference between previous traffic information and current traffic information.

29. The method of claim 25, further comprising: generating supplementary information from the traffic information.

30. The method of claim 29, wherein the supplementary information comprises at least one of a difference in TOA (Time of Arrival), a gap between the rerouted path and an original path, or a cause of change.

31. The method of claim 30, wherein said displaying the rerouted path comprises displaying the supplementary information.

32. A computer-readable storage medium having stored thereon computer instructions that, when executed by a computer, cause the computer to perform a method comprising:
retrieving standard traffic information from a memory;
receiving an updated part of traffic information;
generating traffic data based at least in part on the updated part of the traffic information and the standard traffic information; and
rerouting a path according to the traffic data.
